(19) United States
(12) Patent Application Publication
(10) Pub. No.: US 2015/0152889 A1
(43) Pub. Date: Jun. 4, 2015

(54) SYSTEM FOR IMPROVING THE ENERGY EFFICIENCY IN HYDRAULIC SYSTEMS

(71) Applicant: Hydac Fluidtechnik GmbH, Sulzbach/Saar (DE)

(72) Inventors: Frank Schulz, Blieskastel-Bierbach (DE); Peter Bruck, Althornbach (DE)

(21) Appl. No.: 13/261,912

(22) PCT Filed: Nov. 9, 2012
(86) PCT No.: PCT/EP2012/004654

§ 371 Date: May 30, 2014

(30) Foreign Application Priority Data
Dec. 3, 2011 (EP) 10 2011 120 226.2

(51) Int. Cl. F15B 3/00; F15B 11/072; F15B 11/032

(52) U.S. Cl. CPC F15B 3/00; F15B 11/032; F15B 11/072; F15B 2211/216; F15B 2211/30525; F15B 2211/5152

(57) ABSTRACT

The invention relates to a system for improving the energy efficiency in hydraulic systems, comprising at least one working cylinder (58) which, in an operating state, operates as a consumer of hydraulic energy and, in a different operating state, as a generator of hydraulic energy, and a hydraulic accumulator (1) which, in an operating state of the working cylinder (58), can be charged by the same for storing energy and, in a different operating state, can be discharged for delivering energy to the working cylinder (58). The invention is characterized in that at least one hydraulic accumulator is provided in the form of an adjustable hydropneumatic piston accumulator (1), in which are formed a plurality of pressure chambers (19, 21, 23, 25) which adjoin effective surfaces (11, 13, 15, 17) of different sizes on the fluid side of the accumulator piston (5), and an adjusting arrangement (51) is provided which connects a selected pressure chamber (19, 21, 23, 25) or a plurality of selected pressure chambers (19, 21, 23, 25) of the piston accumulator (1) to the working cylinder (58) as a function of the pressure level that prevails respectively on the gas side of the piston accumulator (1) and on the working cylinder (58).

The invention relates to a system for improving the energy efficiency in hydraulic systems, having at least one working cylinder, which operates as a consumer of hydraulic energy in one operating state, and as a generator of hydraulic energy in another operating state, and having a hydraulic accumulator, which can be charged by the working cylinder for storing energy in one operating state of the working cylinder, and which can be discharged for delivering energy to the working cylinder in another operating state.

Given the increasing scarcity of resources and the increased efforts to save energy associated therewith, systems of the type described above are becoming increasingly important. For this reason, such systems are frequently used in hydraulic equipment and systems, in which actuators in the form of working cylinders are provided. In the case of raising and lowering applications, the potential energy of a load that has been lifted can thereby be converted into hydraulic energy by means of the working cylinder, which energy can be stored and fed back. Such a system can also be used for load compensation.

In the relevant systems of this kind from the prior art, the efficiency of the energy conversion leaves something to be desired. One reason for this is the dependency of the charging and discharging processes of the hydraulic accumulator on the respective system pressure. More specifically, the hydraulic accumulator can only be charged when the system pressure is greater than the gas pressure present in the accumulator on the gas side. If the system pressure cannot be established in the respective operating situation of the working cylinder, it will not be possible to acquire energy in the accumulator. The discharging process of the accumulator is thus subject to limitation if energy from the accumulator can only be fed back when the accumulator pressure is greater than the current system pressure. There is an additional problem in the fact that, in the case of an accumulator pressure that is greater than the current, needed system pressure at the working cylinder, it is necessary to balance the pressure level of the accumulator and the system by means of valves, so that the energy, which is latent in the differential pressure between the accumulator pressure and the system pressure, is lost as a result of throttling losses.

DE 100 06 013 A1 discloses a device for saving energy in hydraulically actuated work equipment through the use of a piston accumulator. In the known solution, a fluid control has a control device, by means of which the piston accumulator can be connected to, or disconnected from, a fluid circuit of the work equipment, and the control device has a monitoring device for such switching operations, which at least detects system conditions of the work equipment and/or of the piston accumulator, with the result that the device for saving energy is only used when an actuation of the work equipment appears to be necessary during normal operation, wherein special operations with the machine, in which the work machine is completely unloaded or very heavily loaded, are not hindered. A favorable energy conversion is thereby achieved with the known solution.

Starting from this prior art, the object of the invention is to provide a system of the type under consideration that allows an even more favorable energy conversion.

This object is achieved according to the invention by a system, which has the features of claim 1 in its entirety.

Accordingly, an essential feature of the invention is that at least one hydraulic accumulator is provided, which provides an adjustment option, whereby said accumulator provides a plurality of pressure chambers, which are adjacent to active surfaces of different sizes on the fluid side of the accumulator piston, wherein an adjustment assembly is provided, which connects a selected pressure chamber or a plurality of selected pressure chambers of the piston accumulator to the working cylinder, depending on the respective prevailing pressure level on the gas side of the piston accumulator and at the working cylinder. This provides the possibility of recycling energy regardless of the pre-charge pressure on the gas side of the accumulator and independently of the respective load pressure, because the respective desired pressure level at the accumulator can be used for charging or discharging by selecting an active surface of the appropriate size. An optimal energy conversion is thereby possible for all operating states.

In addition, the use of such a “multi-step accumulator” makes it possible to influence the loading time by selecting the effective surfaces. If a small surface is selected at a constant volume flow for example, this will result in a short loading time of the accumulator, while if a large surface is selected at a constant volume flow, this will result in a longer loading time. A finer or coarser pressure gradation can be obtained by forming a larger or smaller number of pressure chambers of different effective piston surfaces. More than one accumulator having different pressure chambers could also be provided in order to achieve particularly high degree of resolution.

In an especially advantageous manner, a control logic unit may be associated with the adjustment assembly, which logic unit processes the signals from sensor devices for the control of the valves associated with the adjustment assembly, said sensor devices displaying the pressure level on the gas side of the piston accumulator and the respective operating state of the working cylinder. The logic unit thereby controls the energy transformation by deciding how the accumulator should be charged or discharged based on the load condition at the working cylinder and the load condition at the accumulator. In so doing, it is possible for the user to influence the logic unit by entering his own presets, and thereby determine the load characteristic of the system.

With regard to the construction of the piston accumulator, the configuration may be advantageously made such that the accumulator piston is configured as a step piston for the formation of active surfaces of different sizes, and that said piston has partial piston surfaces that are adjacent to cylinder surfaces on the fluid side thereof, wherein the accumulator housing has corresponding mating surfaces that are adjacent to cylinder surfaces, which mating surfaces together with partial piston surfaces associated therewith, each delimit separate pressure chambers.

Active surfaces on the accumulator piston and mating surfaces on the accumulator housing are preferably disposed at an axial spacing to one another, and the active surfaces and mating surfaces may be provided in the form of annular surfaces or circular surfaces, which are disposed concentrically to the longitudinal axis.

In terms of controlling the pressure chambers of the piston accumulator, the configuration may be advantageously made such that the adjustment assembly has selector valves, by means of which the respective pressure chambers of the piston accumulator,

which are selected for charging or discharging, can be connected to the working cylinder, and the remaining pressure chambers can be connected to the tank. Controlled by the control logic unit, a selected pressure chamber or a combination of selected pressure chambers can be connected to the working cylinder for charging or discharging, while non-selected pressure chambers can be emptied without pressure to the tank during the discharging of the active pressure chamber, and refilled from the tank during the charging of the active pressure chambers.

In terms of the supply of signals to the control logic unit, the configuration may be advantageously made in such a way that the associated sensor device has at least pressure sensors, which provide signals to the control logic unit, which signals indicate the filling pressure on the gas side of the piston accumulator and the system pressure at the working cylinder. In addition, a position sensor is preferably provided at the working cylinder, which signals the piston position and/or piston speed of the working cylinder.

In especially advantageous embodiments, the adjustment assembly comprises a main line that is connected to the pressure side of a hydraulic pump, as well as connecting lines that run therefrom to the fluid ports of the piston accumulator, wherein these connecting lines can each be selectively blocked, released or connected to the tank by means of the switching valves.

The invention is explained in detail below based on the drawings.

Shown are:

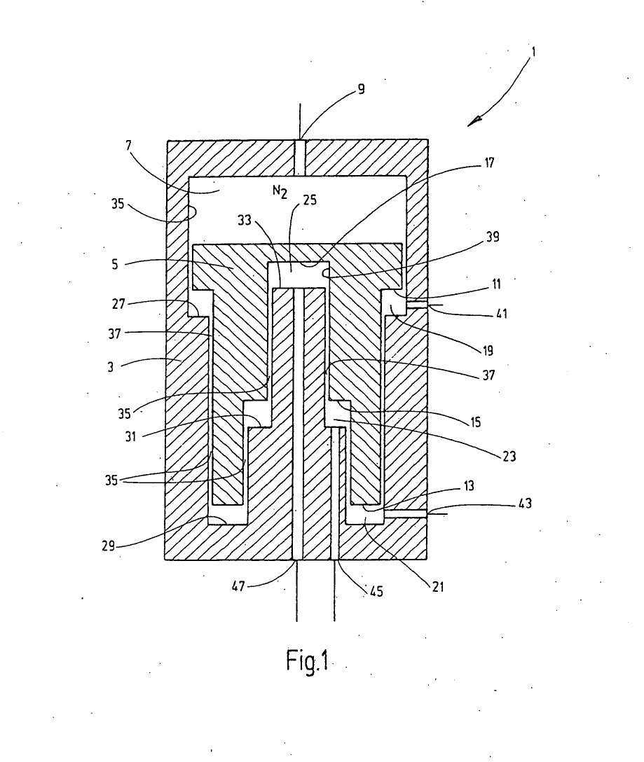

FIG. 1 a highly schematic, simplified longitudinal section of an embodiment of a hydropneumatic piston accumulator in a multi-stage design for use in the system according to the invention;

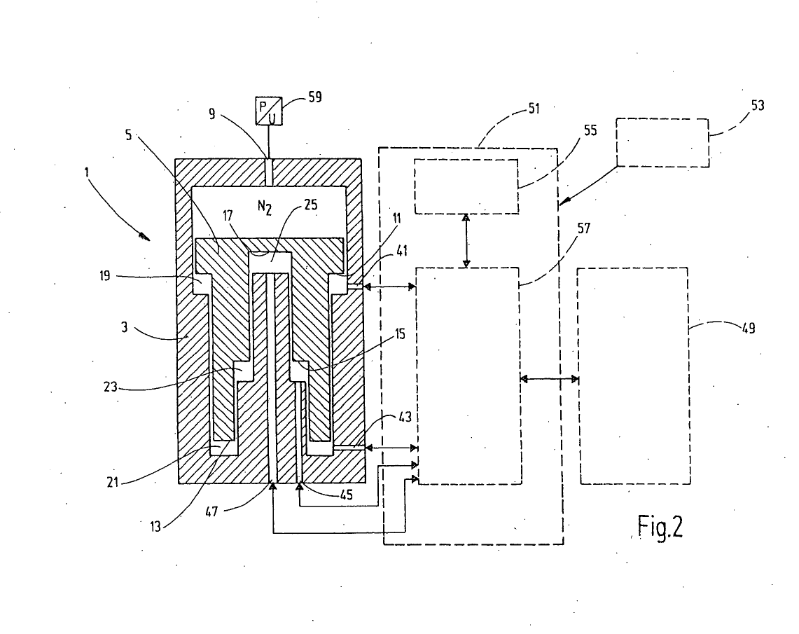

FIG. 2 a schematic diagram that shows the piston accumulator from FIG. 1 in conjunction with associated system components of the system according to the invention;

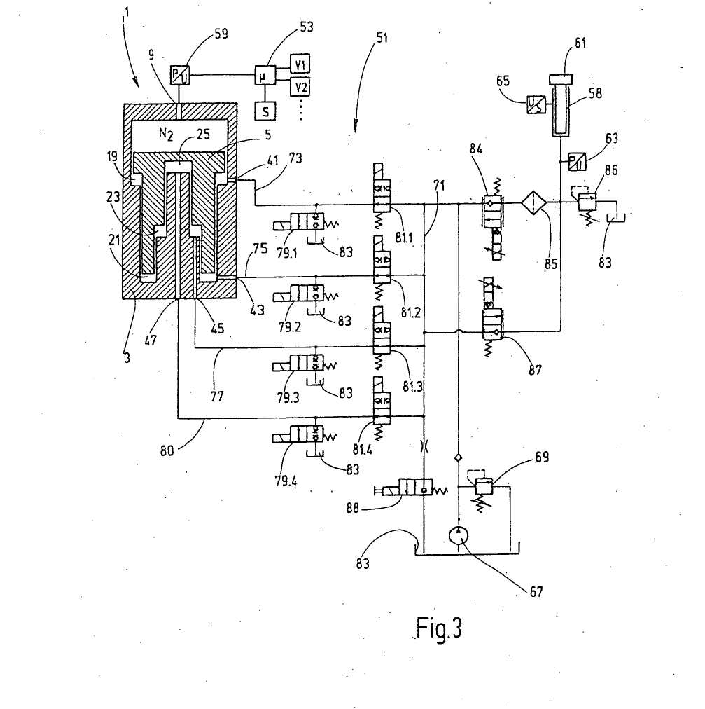

FIG. 3 the piston accumulator in conjunction with a hydraulic circuit diagram of an embodiment of the system for a raising and lowering application and

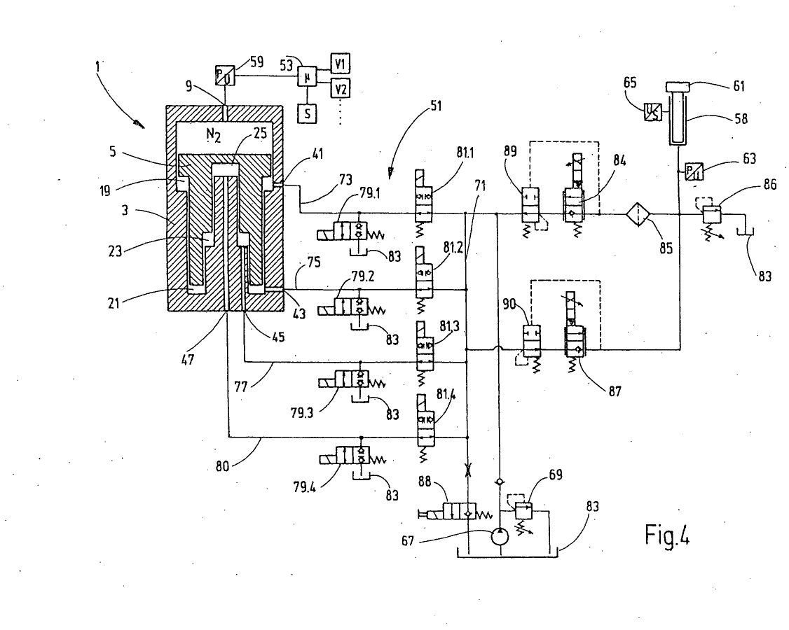

FIG. 4 a depiction of a modified embodiment of the raising and lowering application depicted in FIG. 3.

The hydropneumatic piston accumulator 1, which is shown in a schematic, simplified depiction in FIG. 1, has an accumulator piston 5 that is axially movably guided in an accumulator housing 3, which accumulator piston separates a gas side 7, on which a filling port 9 is located, from fluid-side pressure chambers in the accumulator housing 3. The accumulator piston 5 is configured in the manner of a step piston such that, in combination with corresponding stepped portions of the accumulator housing 3, said accumulator piston delimits fluid-side pressure chambers 19, 21, 23 and 25, which are adjacent to active surfaces of different sizes on the fluid side of the accumulator piston 5. FIG. 1 designates these active surfaces 11, 13, 15 and 17, from the largest surface to the smallest surface. Here, the active surfaces 11, 13 and 15 are each formed by annular surfaces disposed concentrically relative to the longitudinal axis, which surfaces surround the inner-most active surface 17 in the form of a circular surface. Pressure chambers 19, 21 or 23, respectively, which are adjacent to the active surfaces 11, 13 and 15, are delimited by mating surfaces 27 or 29 or 31, respectively, of the accumulator housing 3, as well as by cylinder surfaces 35 of the cylinder housing 3 and cylinder surfaces 37 on the accumulator piston 5.

The pressure chamber 25 adjacent to the active surfaces 17 is delimited by a mating surface 33 of the accumulator housing 3 as well as a cylinder surface 39 of the accumulator piston 5.

A fluid port 41, 43, 45 or 47, respectively, is provided for each pressure chamber 19, 21, 23, 25. Just as the active surfaces 11, 13, 15 and 17 are disposed on the accumulator piston 5, the associated mating surfaces 27, 29, 31 or 33, respectively, are disposed on the accumulator housing 3 in steps that are axially spaced relative to one another.

FIG. 2 shows the piston accumulator 1 in conjunction with associated system components, wherein an actuator 49 is operatively connected to an adjustment assembly 51. As already noted, a working cylinder 58 (FIG. 3) may be provided as an actuator 49, which cylinder may be a component in a raising and lowering assembly, for example. A control logic unit 53 is associated with the adjustment assembly 51, which logic unit actuates a valve arrangement 57 of the adjustment assembly 51 by means of a control and regulation unit 55. As will be explained in greater detail on the basis of FIGS. 3 and 4, the valve arrangement 57 has selector valves, which produce selected fluid connections between the actuator 49 and the fluid ports 41, 43, 45, 47 of the piston accumulator 1, in order to selectively activate the pressure chambers 19, 21, 23 and 25 for charging and discharging processes. To this end, the control logic unit 53 processes signals, which are provided by sensor devices and which represent the operating states of actuator 49 and piston accumulator 1. Only one of the sensor devices, a pressure sensor 59 at the filling port 9 of the piston accumulator 1, is shown in FIG. 2.

FIG. 3 shows the system according to the invention in conjunction with a raising and lowering assembly, wherein the actuator has a working cylinder 58 for raising and lowering a load 61. A pressure sensor 63 that detects the load pressure, and a position sensor 65 that detects a raising and lowering speed are provided on the working cylinder 58, in order to generate the signals that are to be processed by the control logic unit 53. A hydraulic pump 67, which is secured on the output side by a pressure relief valve 69, is connected to a main line 71 of the adjustment assembly 51, which guides the system pressure. This assembly has a connecting line 73, 75, 77 and 80 respectively, for the connection between the main line 71 and each of the fluid ports 41, 43, 45 and 47 of the piston accumulator 1. A valve group, which is actuated by the control logic unit 53 actuated, and symbolically designated as v₁, v₂, etc., is located in each of the connecting lines, wherein each valve group is formed by two fast switching 2/2-way-valves, which are designated as 79 and 81, and which are identified with indices 1 to 4 for the valve groups v₁ to v₄. Each of the connecting lines can be connected to, or blocked from, the associated fluid port of the piston accumulator 1 by means of the directional valves 81. The respective connecting line 73, 75, 77, 80 can be connected to the tank 83 by means of the directional valve 79.

For a lifting process, the main line 71 can be connected to the working cylinder 58 by means of a valve, which is designed as a proportional choke valve 87 for the control of the lifting speed. The flow is started through the fluid filter 85 when the working cylinder 58 is lowered. In addition, a pressure relief valve 86 is used to secure the relevant hydraulic circuit. The lifting movement is achieved with the aid of the energy stored in the piston accumulator by means of a discharge process from the selected pressure chamber 19, 21, 23, 25, or from a plurality of selected pressure chambers, which have the appropriate pressure level for the lifting movement of the load 61. In the case of lowering movements, the potential energy of the load 61 is stored as hydraulic energy in the piston accumulator 1, whereby a charging process occurs by means of a proportional choke valve 84 that adjusts the lowering speed and a selected connecting line 73, 75, 77, 80, or by means of a plurality of selected connecting lines to a corresponding fluid port 41, 43, 45, 47, wherein one or more of the directional valves 81 is or are opened, respectively, and directional valves 79 of non-selected connecting lines establish the connection to the tank 83. Through this connection, non-selected pressure chambers 19, 21, 23, 25 of the piston accumulator 1 are depressurized during discharge processes, and can be refilled from the tank 83 during charging processes. A directional valve 88 located on the main line 71 makes it possible to depressurize or empty the system as needed.

During operation, in order to lower a load with energy-recovery, the load pressure at the cylinder 58 is transmitted to the control logic unit 53 by means of the pressure sensor 63, and the gas pressure in the accumulator 1 is likewise transmitted, which is determined by the pressure sensor 59. By means of this information, a decision can be made by the control system, as to how the available potential energy of the cylinder 58 can be optimally fed back into the accumulator 1. In the case of low loads, a large effective surface is selected, in order to charge the accumulator to a high pressure level. If there is a load 61 on the cylinder 58, the accumulator 1 is charged with a smaller effective surface. The lowering speed of the load is adjusted by means of the proportional choke valve 84.

The load compensation effected by the system may be done discontinuously by selecting and/or switching the suitable effective surfaces, wherein if a sufficiently large number of pressure levels provided in the accumulator 1, a resolution can be achieved that allows a load to be smoothly lowered. In order to lift a load 61, with or without the help of the pump 67, when the piston accumulator 1 is loaded, the appropriate effective surface or effective surfaces are selected according to the load 61 on the cylinder 58 depending on the gas pressure in the accumulator 1. In order to smoothly start up the movement of the load 61, a lower pressure level is preferably initially selected. The speed of raising the load 61 is adjusted by means of the proportional choke valve 87, wherein the pressure differential is kept as small as possible by means of appropriately selecting the effective surfaces of the accumulator 1, so that a low-loss conversion of the stored energy into lifting force is made possible.

The embodiment in FIG. 4 only differs from the example in FIG. 3 in that a pressure maintenance valve 89 or 90, respectively, is provided at each of the proportional choke valves 84 and 87, in order to create a constant pressure differential at the associated, proportional choke valve 84, 87. Jumps in the pressure differential at the respective proportional choke valve 84, 87 can be compensated for by switching the effective surfaces of the accumulator 1.

If fast-switching directional valves 79 and 81 are used instead of the proportional choke valves 84, 87, these directional valves may also be controlled by pulse-width modulation, whereby a desired average flow rate can be adjusted to, depending on the impulse modulation.

1. A system for improving the energy efficiency in hydraulic systems, having at least one working cylinder (58), which operates as a consumer of hydraulic energy in one operating state, and as a generator of hydraulic energy in another operating state, and having a hydraulic accumulator (1), which can be charged by the working cylinder for storing energy in one operating state, of the working cylinder (58), and which can be discharged for delivering energy to the working cylinder (58) in another operating state, characterized in that at least one hydraulic accumulator is provided in the form of an adjustable hydropneumatic piston accumulator (1), in which a plurality of pressure chambers (19, 21, 23, 25) are formed, which adjoin effective surfaces (11, 13, 15, 17) of different sizes on the fluid side of the accumulator piston (5), and that an adjustment assembly (51) is provided, which connects a selected pressure chamber (19, 21, 23, 25) or a plurality of selected pressure chambers (19, 21, 23, 25) of the piston accumulator (1) to a working cylinder (58), depending on the respective pressure level that prevails on the gas side of the piston accumulator (1) and at the working cylinder (58).

2. The system according to claim 1, characterized in that a control logic unit (53) is associated with the adjustment assembly (51), which logic unit processes the signals from sensor devices (59, 63) for the control of the valves (79, 81) associated with the adjustment assembly (51), which displays the pressure level on the gas side of the piston accumulator (1) and the respective operating state of the working cylinder (58).

3. The system according to claim 1, characterized in that the accumulator piston (5) is configured as a step piston for the formation of different active surfaces (11, 13, 15, 17) and has partial piston surfaces that are adjacent to cylinder surfaces (35, 37, 39) on the fluid side thereof, and in that the accumulator housing (3) has corresponding mating surfaces (27, 29, 31, 33) that are adjacent to cylinder surfaces (35, 37), which mating surfaces, together with the partial piston surfaces associated therewith, each delimit separate pressure chambers (19, 21, 23, 25).

4. The system according to claim 1, characterized in that active surfaces (11, 13, 15, 17) on the accumulator piston (5) and mating surfaces (27, 29, 31, 33) on the accumulator housing (3) are disposed in steps that are located at an axial spacing from one another.

5. The system according to claim 1, characterized in that effective surfaces (11, 13, 15, 17) and mating surfaces (27, 29, 31, 33) are provided in the form of annular surfaces or circular surfaces, which are disposed concentrically to the longitudinal axis.

6. The system according to claim 1, characterized in that the adjustment assembly (51) has selector valves (79, 81), by means of which respective pressure chambers (19, 21, 23, 25), which are selected for charging or discharging, can be connected to the working cylinder (58), and the remaining pressure chambers (19, 21, 23, 25) can be connected to the tank (83).

7. The system according to claim 2, characterized in that the sensor devices has at least pressure sensors (59, 63), which supply signals for the control logic unit (53), which signals display the fluid pressure on the gas side of the piston accumulator (1) and system pressure at the working cylinder (58).

8. The system according to claim 1, characterized in that the adjustment assembly (51) comprises a main line (71) that is connected to the pressure side of a hydraulic pump (67), as well as connecting lines (73, 75, 77, 80) that run therefrom to the fluid ports (41, 43, 45, 47) of the piston accumulator (1), and in that these connecting lines can each be selectively blocked, released or connected to the tank (83) by means of the switching valves (79, 81).
